(19) United States
(12) Patent Application Publication
(10) Pub. No.: US 2025/0322120 A1
(43) Pub. Date: Oct. 16, 2025

(54) METHOD, DEVICE, AND PROGRAM PRODUCT FOR PROCESSING SIMULATION DATA OF COMPUTATIONAL FLUID DYNAMICS

(71) Applicant: Dell Products L.P., Round Rock, TX (US)

(72) Inventors: Qiang Chen, Shanghai (CN); Pedro Fernandez Orellana, Surfers Paradise (AU)

(21) Appl. No.: 18/654,833

(22) Filed: May 3, 2024

(30) Foreign Application Priority Data
Apr. 12, 2024 (CN) 202410444691.8

(51) Int. Cl. G06F 30/27; G06F 30/28

(52) U.S. Cl. CPC G06F 30/27; G06F 30/28

(57) ABSTRACT

Illustrative embodiments include a method, an electronic device, and a program product for processing simulation data of computational fluid dynamics (CFD). A method in one embodiment includes: training, based on acquired CFD simulation sample data, a neural network model to obtain a trained neural network model, wherein the CFD simulation sample data includes: a CFD simulation condition sample value, sample data of an input parameter, and simulation sample data of an output parameter at the CFD simulation condition sample value; and generating a file associated with the trained neural network model, wherein the file includes a network parameter value of the trained neural network model, and the file is used for reconstructing the neural network model to provide CFD simulation data. According to the method in embodiments of the present disclosure, the trained neural network model can automatically provide CFD simulation data.

### RELATED APPLICATION

The present application claims priority to Chinese Patent Application No. 202410444691.8, filed Apr. 12, 2024, and entitled “Method, Device, and Program Product for Processing Simulation Data of Computational Fluid Dynamics,” which is incorporated by reference herein in its entirety.

### FIELD

Embodiments of the present disclosure relate to the field of computer processing, and more particularly, to a method, an electronic device, and a computer program product for processing simulation data.

### BACKGROUND

Computational fluid dynamics (CFD) uses a numerical method through a computer to solve control equations of fluid dynamics, thereby predicting fluid flow, and obtaining relevant information of the fluid under specific conditions through simulation. Compared with experimental verification, CFD has higher flexibility, lower cost, and faster time to acquire simulation data. Therefore, CFD has been widely used to verify and optimize product designs involving fluid flow and heat transfer.

### SUMMARY

Embodiments of the present disclosure provide a method, an electronic device, and a computer program product for processing simulation data of CFD.

According to a first aspect of the present disclosure, a method for processing simulation data of CFD is provided. The method includes: training, based on acquired CFD simulation sample data, a neural network model to obtain a trained neural network model, wherein the CFD simulation sample data includes: a CFD simulation condition sample value, sample data of an input parameter, and simulation sample data of an output parameter at the CFD simulation condition sample value; and generating a file associated with the trained neural network model, wherein the file includes a network parameter value of the trained neural network model, and the file is used for reconstructing the neural network model to provide CFD simulation data.

According to a second aspect of the present disclosure, an electronic device is provided. The electronic device includes: at least one processor; and a memory, coupled to the at least one processor and having instructions stored therein, wherein the instructions, when executed by the at least one processor, cause the electronic device to perform actions including: training, based on acquired CFD simulation sample data, a neural network model to obtain a trained neural network model, wherein the CFD simulation sample data includes: a CFD simulation condition sample value, sample data of an input parameter, and simulation sample data of an output parameter at the CFD simulation condition sample value; and generating a file associated with the trained neural network model, wherein the file includes a network parameter value of the trained neural network model, and the file is used for reconstructing the neural network model to provide CFD simulation data.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform actions including: training, based on acquired CFD simulation sample data, a neural network model to obtain a trained neural network model, wherein the CFD simulation sample data includes: a CFD simulation condition sample value, sample data of an input parameter, and simulation sample data of an output parameter at the CFD simulation condition sample value; and generating a file associated with the trained neural network model, wherein the file includes a network parameter value of the trained neural network model, and the file is used for reconstructing the neural network model to provide CFD simulation data.

### BRIEF DESCRIPTION OF THE DRAWINGS

By the following Detailed Description of illustrative embodiments of the present disclosure, provided herein with reference to the accompanying drawings, the above and other objectives, features, and advantages of the present disclosure will become more apparent, wherein identical reference numerals generally represent identical components in the illustrative embodiments of the present disclosure, and in which:

FIG. 1 is a schematic diagram of an example environment in which embodiments of the present disclosure can be implemented;

FIG. 2 is a flow chart of a method for processing simulation data of CFD according to an embodiment of the present disclosure;

FIG. 3 illustrates an example process of performing data sampling from simulation data of CFD according to an embodiment of the present disclosure;

FIG. 4 is a block diagram of an example training process of performing training on a neural network model according to an embodiment of the present disclosure;

FIG. 5 is a block diagram of system that includes a neural network model according to an embodiment of the present disclosure;

FIG. 6 is a schematic diagram of performing a query operation on a neural network model according to an embodiment of the present disclosure; and

FIG. 7 is a block diagram of an example device that can be used to implement embodiments of the present disclosure.

In various accompanying drawings, identical or corresponding reference numerals represent identical or corresponding parts.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

Simulating information technology (IT) devices through CFD is a widely used method for performing analysis (such as thermal analysis) on IT devices. Compared with an experimental method, CFD has many advantages. For example, CFD does not have requirements on a testing device and can obtain results faster.

In a CFD simulation process, it is necessary to create a mesh for a simulated object. In order to maintain the numerical accuracy of complex set shapes commonly found in IT devices, a large-scale mesh is required. Correspondingly, a “data file” saved after CFD simulation must also include values of all simulation physical parameters (or variables) (such as flow velocity, pressure, temperature, and turbulence variables) for each unit or node in the mesh. Taking a thermal simulation model as an example, a current thermal simulation model may typically contain hundreds of millions of units, and therefore, data files may also be very large and easily reach tens of gigabytes (GB). The large size of data files imposes a limitation to data analysis, as loading a single data file may require hundreds of GB of memory, which is not ideal for most ordinary engineers.

In addition, typically, data files will be further executed and processed by “post-processing” software to perform various types of analyses on the device. However, post-processing software in the current technology requires operators to be able to understand the CFD technology, which puts higher requirements on users who operate the post-processing software. In addition, the post-processing software also requires expensive licenses to be installed.

Therefore, in order to solve at least one of the above problems and other potential problems, an embodiment of the present disclosure provides a method for processing simulation data of CFD. The method includes: training, based on acquired CFD simulation sample data, a neural network model to obtain a trained neural network model, wherein the CFD simulation sample data includes: a CFD simulation condition sample value, sample data of an input parameter, and simulation sample data of an output parameter at the CFD simulation condition sample value; and generating a file associated with the trained neural network model, wherein the file includes a network parameter value of the trained neural network model, and the file is used for reconstructing the neural network model to provide CFD simulation data.

The method trains the neural network model using the CFD simulation sample data under a given operating condition (such as a simulation condition), allowing the neural network model to learn information in a flow field, thereby being capable of automatically providing CFD simulation data. Therefore, it can effectively avoid using large data files to store simulation data. In addition, the trained neural network model can support the function of the post-processing software (such as providing simulation data of CFD in various forms and/or analyzing simulation data), and can also provide simpler and more convenient query methods, so that it is more convenient for users to use and operate.

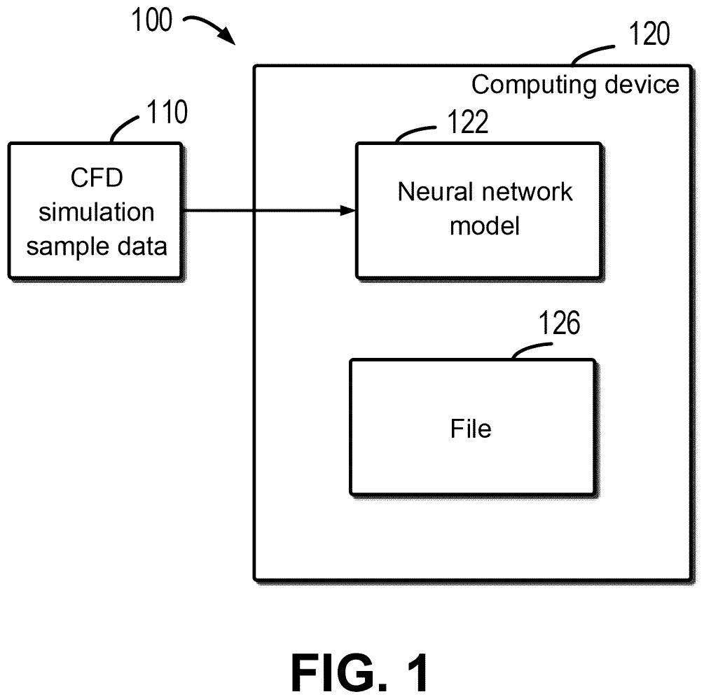

Embodiments of the present disclosure will be further described in detail with reference to the accompanying drawings below. FIG. 1 is a schematic diagram of an example environment 100 in which embodiments of the present disclosure can be implemented.

The example environment 100 includes a computing device 120, and the computing device 120 includes a neural network model 122. In some embodiments, the neural network model 122 may include a deep neural network model. The computing device 120 can train the neural network model 122 to obtain a trained neural network model. In some embodiments, the computing device 120 may receive CFD simulation sample data 110 and train the neural network model 122 using the received CFD simulation sample data 110. The computing device 120 may further generate a file 126 associated with the trained neural network model 122, and the file 126 is used (for example, at another computing device) for reconstructing the neural network model 122 to provide CFD simulation data. The neural network model reconstructed based on the file 126 may provide, based on a received query request, CFD simulation data corresponding to the query request.

The computing device 120 includes, but is not limited to, a personal computer, a server computer, a handheld or laptop device, a mobile device (such as a mobile phone, a personal digital assistant (PDA), and a media player), a multiprocessor system, a consumer electronic product, a wearable electronic device, a smart home device, a minicomputer, a mainframe computer, an edge computing device, a distributed computing environment including any of the above systems or devices, and the like.

In some embodiments, the computing device 120 may train the neural network model 122 based on the acquired CFD simulation sample data 110 to obtain the trained neural network model 122. In some embodiments, the CFD simulation sample data 110 may include: a CFD simulation condition sample value, sample data of an input parameter, and simulation sample data of an output parameter at the CFD simulation condition sample value. The computing device 120 may generate the file 126 associated with the trained neural network model 122. The file 126 may include a network parameter value of the trained neural network model, and the file is used for reconstructing the neural network model to provide CFD simulation data.

The method trains the neural network model using the CFD simulation sample data under a given operating condition (such as a simulation condition), allowing the neural network model to learn information in a flow field, thereby being capable of automatically providing CFD simulation data. Therefore, it can effectively avoid using large data files to store simulation data. In addition, the trained neural network model can support the function of the post-processing software (such as providing simulation data of CFD in various forms and/or analyzing simulation data), and can also provide simpler and more convenient query methods, so that it is more convenient for users to use and operate.

Therefore, the method for processing simulation data of CFD according to embodiments of the present disclosure may be applied to perform CFD simulation on various physical parameters (such as temperature, velocity, and pressure) of devices in, for example, high-performance computing systems, computer groups, or storage systems, and acquire the simulation data for analysis. Moreover, the method for processing CFD simulation data according to embodiments of the present disclosure has good application prospects because of its advantages of low cost, fast acquisition of simulation data, and the like.

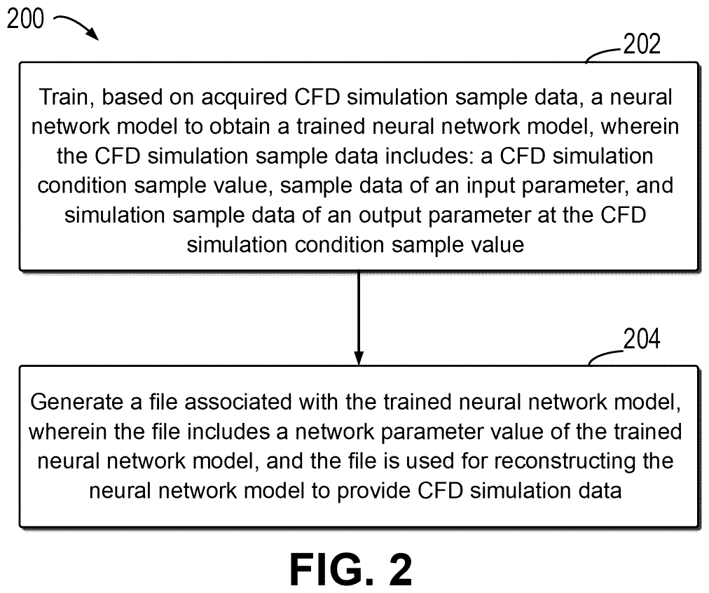

A block diagram of the example environment 100 in which embodiments of the present disclosure can be implemented has been described above with reference to FIG. 1. A flow chart of a method 200 for processing simulation data of CFD according to an embodiment of the present disclosure is described below with reference to FIG. 2. The method 200 may be performed at the computing device 120 in FIG. 1 and any suitable computing device.

At block 202, the computing device may train the neural network model based on the acquired CFD simulation sample data to obtain the trained neural network model. In some embodiments, the CFD simulation sample data may include: a CFD simulation condition sample value, sample data of an input parameter, and simulation sample data of an output parameter at the CFD simulation condition sample value.

The neural network model may include the neural network model 122 as shown in FIG. 1. In some embodiments, the neural network model 122 may include a deep neural network. It is to be understood that the structure of neural network model is not limited in the present disclosure, and those skilled in the art can choose neural network models with appropriate structures for training according to actual needs.

In some embodiments, the CFD simulation sample data may come from online simulation data obtained by performing CFD simulation on a target device (for example, CFD simulation that performs thermal analysis and the like on an IT device). That is, online simulation data may be accessed and the read CFD simulation data may be used as the CFD simulation sample data. In some embodiments, the CFD simulation sample data may include: a CFD simulation condition sample value, sample data of an input parameter, and simulation sample data of an output parameter at the CFD simulation condition sample value. In some embodiments, each piece of CFD simulation sample data may be represented in the form of a tuple, for example, <sample data of an input parameter, simulation condition sample value, simulation sample data of an output parameter at the simulation condition sample value>.

Illustration is made by taking the performance of thermal analysis on an IT device as an example. For example, the IT device may be one or a plurality of computing devices. Through CFD simulation, the working temperature of one or a plurality of computing devices may be simulated to perform thermal analysis of working conditions of the devices. In the example, an operating condition may be set for each computing device Ei among the one or a plurality of computing devices. In some embodiments, the operating condition may include a parameter that characterizes heating and/or a parameter that characterizes the ambient temperature. In some embodiments, the processor load may be used as a parameter that characterizes heating, and the fan speed may be used for characterizing the ambient temperature. Therefore, the operating condition may be set by setting the processor load and/or fan speed. In some embodiments, a plurality of operating conditions may be set, and CFD simulation may be performed on an object under each operating condition, thereby obtaining sample data of an output parameter corresponding to sample data of an input parameter under each operating condition. In some embodiments, the input parameter may include coordinates (for example, spatial coordinates) in a mesh constructed based on the simulated object. Correspondingly, a value of the input parameter may include a value of coordinates in the mesh (such as a spatial coordinate value). The output parameter may include one or more of temperature, flow velocity, or pressure.

For example, a first operating condition may be set, and in the first operating condition, the processor load is set to a1% (wherein 0<a1<100), and the fan speed is set to b1. Based on the set first operating condition (for example, the processor load being a1% and the fan speed being b1), CFD simulation is performed on the computing device Ei, and simulation data of CFD of the output parameter corresponding to a value of the input parameter under the corresponding first operating condition may be obtained. For example, the CFD simulation sample data may include: a value (x₁, y₁, z₁) of a first coordinate in the mesh; a CFD simulation sample condition value (the processor load being a1% and the fan speed being b1); and at the CFD simulation sample condition value, the temperature T₁, flow velocity V₁, and pressure P₁ at the coordinate value (x₁, y₁, z₁). The simulation sample data may be, for example, represented as <x₁, y₁, z₁, a1%, b1, T₁, V₁, P₁>.

In addition, a second operating condition may further be set, and in the second operating condition, the processor load is set to a2% (wherein 0<a2<100), and the fan speed is set to b2. Based on the set second operating condition (for example, the processor load being a2% and the fan speed being b2), CFD simulation is performed on the computing device Ei, and a CFD simulation value of the output parameter corresponding to a value of the input parameter under the corresponding second operating condition may be obtained. For example, the CFD simulation sample data may include: a value (x₂, y₂, z₂) of a second coordinate; a CFD simulation sample condition value (the processor load being a2% and the fan speed being b2); and at the CFD simulation sample condition value, the temperature T₂, flow velocity V₂, and pressure P₂ of an object at the coordinate value (x₂, y₂, z₂). The simulation sample data may be, for example, represented as <x₂, y₂, z₂, a2%, b2, T₂, V₂, P₂>.

It is to be understood that the above is illustrated by using CFD simulation sample data obtained during performing thermal analysis on an IT device as an example. When CFD simulation is used for other types of fluid analyses, appropriate CFD simulation sample data may be obtained for training a neural network. The present disclosure does not limit the specific types or specific values of the CFD simulation sample data. In addition, a detailed training process of the neural network model will be described below with reference to the accompanying drawings. At block 204, the computing device may generate a file associated with the trained neural network model, the file may include a network parameter value of the trained neural network model, and the file is used for reconstructing the neural network model to provide CFD simulation data.

In some embodiments, the computing device 120 may acquire the file 126 associated with the trained neural network model after the trained neural network model is obtained. The file 126 is used to reconstruct the neural network model on a computing device (such as a second computing device) that is separate from the computing device 120 to provide the CFD simulation data. In other words, when the trained neural network model may be used as a post-processing software for CFD simulation, not only can post-processing operations of CFD simulation be implemented locally on the computing device 120, but the generated file 126 may also be used to implement post-processing operations of CFD simulation on another (some other) computing device(s) (such as the second computing device), thereby greatly expanding the application range of the neural network model and also bringing great convenience to user operations.

In some embodiments, the file 126 may include a network parameter value of the trained neural network model. The file 126 may further include a network structure of the trained neural network model. Based on the network parameter value and the network structure in the file, the second computing device may reconstruct the trained neural network model 122 for post-processing in CFD simulation. For example, simulation data of CFD may be obtained and analyzed through querying operations.

In addition, in some embodiments, the file 126 may include one or more of the following: a range of coordinates, wherein the coordinates are associated with the shape of an object on which CFD simulation is performed; a continuous range of a first parameter related to the CFD simulation; a discrete range of a second parameter related to the CFD simulation; or a confidence interval.

In some embodiments, the coordinates may be coordinates on a mesh constructed based on the simulated object, and the coordinates are correspondingly associated with the shape of the simulated object. In some embodiments, the range of coordinates may represent a range of coordinate values from small to large. For example, the coordinates may include spatial coordinates, and correspondingly, the range of coordinates may represent a coordinate range in an X-axis, a coordinate range in a Y-axis, and a coordinate range in a Z-axis of the coordinate values.

In some embodiments, the first parameter related to the CFD simulation may include, for example, temperature, device load, and the like. Correspondingly, the continuous range of the first parameter related to the CFD simulation may include a temperature range, a load range, and the like. The range of data may be stored as a tuple that includes both maximum and minimum values.

In some embodiments, the second parameter related to the CFD simulation may include, for example, fan type, operating mode of a hard disk drive (HDD), and the like. The discrete range may be identified as a set of available options. For example, the discrete range of the second parameter related to the CFD simulation may be expressed as: fan type {high performance; low performance}; HDD operating mode {sleep mode; activation mode}, and the like.

In some embodiments, in the training process of the neural network model 122 by the computing device 120, a reconstruction error for verification data may be recorded, and the reconstruction error may be used as a confidence interval for output and stored in the file 126 as metadata in the file 126.

Table 1 below shows an example of a structure of the file 126 according to an embodiment of the present disclosure. It should be understood that numerical values in Table 1 are only examples and for illustrative purposes. Depending on the parameter and structure of the actual neural network model and CFD simulations performed for different IT devices, the values and/or corresponding parameters in the file 126 may vary.

TABLE 1

| | |
|---|---|
| Description | Content |

| | | |
|---|---|---|
| Metadata section | X-axis coordinate range | [−0.16, 0.16] |
| | Y-axis coordinate range | [0, 0.63] |
| | Z-axis coordinate range | [1.2, 2.5] |
| | Fan type | {0, 1} |
| | (high-performance Y/N) | |
| | Temperature T | [18, 26] |
| | (degrees Celsius) | |

| | |
|---|---|
| Data section | Parameter values and network |
| | structure of the neural network model |

In some embodiments, the second computing device may reconstruct the trained neural network model 122 based on the file 126 for post-processing in the CFD simulation. For example, simulation data of CFD may be obtained and analyzed through querying operations for the neural network model. Therefore, by training the neural network model, a post-processing software function may be provided (such as providing simulation data of CFD in various forms).

It is advantageous to train the neural network model using the CFD simulation sample data under a given operating condition, so that the neural network model can learn information in a flow field and automatically provide CFD simulation data. Therefore, it can effectively avoid using large data files to store simulation data. In addition, the trained neural network model can support the function of the post-processing software (such as providing simulation data of CFD in various forms and/or analyzing simulation data), and can also provide simpler and more convenient query methods, so that it is more convenient for users to use and operate.

The process of training the neural network model 122 according to embodiments of the present disclosure will be described below with reference to the accompanying drawings. It is to be understood that a detailed description of the training process of the neural network model 122 will be provided below with reference to FIG. 1. Those skilled in the art can understand that the neural network model 122 may also be trained by another device, which is not limited in the present disclosure.

In some embodiments, the computing device 120 may perform a plurality of epochs of training on the neural network model 122, and in each epoch of training, a set of CFD simulation sample data including a plurality of pieces of CFD simulation sample data is used. In some embodiments, each piece of CFD simulation sample data may be represented in the form of a tuple, for example, <sample data of an input parameter, simulation condition sample value, and simulation sample data of an output parameter at the simulation condition sample value>. In other words, the CFD simulation sample data acquired by the computing device 120 training the neural network model 122 includes a plurality of sets of sampled CFD simulation sample data, and the plurality of sets of sampled CFD simulation sample data correspond to a plurality of epochs of training performed on the neural network model, respectively.

In some embodiments, each piece of CFD simulation sample data includes: sample data of an input parameter (such as coordinates); a CFD simulation condition sample value; and at the CFD simulation condition sample value, simulation sample data of an output parameter (such as one or more of temperature, flow velocity, or pressure) corresponding to the input parameter. In some embodiments, a set of CFD simulation sample data used during each epoch of training of the neural network model may be obtained by sampling the (online) CFD simulation sample data set.

In some embodiments, values of input parameters (such as values of spatial coordinates) in the plurality of sets of CFD simulation sample data are different from each other.

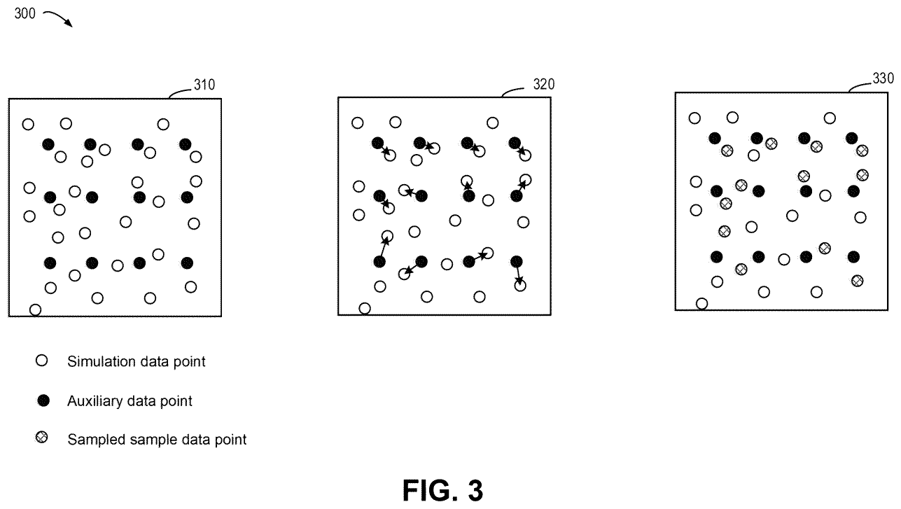

The process of acquiring sampled simulation sample data by the computing device 120 before performing each epoch of training on the neural network model 122 will be described below with reference to FIG. 3. In some embodiments, the computing device 120 may acquire simulation data associated with the simulated object before training the neural network model 122, and perform sampling from the acquired simulation data. In some embodiments, the simulation data associated with the simulated object may come from online simulation data of CFD, thereby avoiding the generation of a large data file. FIG. 3 illustrates an example process 300 of performing data sampling from simulation data of CFD according to an embodiment of the present disclosure.

In some embodiments, the computing device 120 may generate a plurality of uniformly distributed auxiliary data points in a data space corresponding to the simulation data. As shown in a block 310 in FIG. 3, white circles are used to represent simulation data in the data space, and black circles may represent a plurality of uniformly distributed auxiliary data points generated in the data space corresponding to the simulation data.

In some embodiments, for each of the generated auxiliary data points, the computing device 120 may “snap” the auxiliary data point to a simulation data point nearest to the auxiliary data point (for example, in an initial non-uniform mesh). The process may refer to the snapping process indicated by arrows in a block 320 in FIG. 3.

In some embodiments, the computing device 120 may remove, in response to two or more auxiliary data points being at the same location after being snapped, a duplicate auxiliary data point from the same location and retain one auxiliary data point at the same location. Although the deduplication process is not shown in FIG. 3, it is to be understood that in a practical operation, for a case where there are two or more auxiliary points at the same location, a duplicate auxiliary data point may be removed from the same location and one auxiliary data point may be retained at that same location.

After the snapping operation and deduplication operation (if any) are completed, the computing device 120 may use the snapped auxiliary data points in the data space as a set of sampled sample simulation data corresponding to the epoch of training, as represented by patterned circles in a block 330 in FIG. 3. These patterned circles may represent a set of CFD simulation sample data sampled during the training of the neural network model.

It is advantageous that, by sampling simulation sample data of CFD with different spatial coordinates during each epoch of training, good coverage of a spatial region can be ensured while further ensuring data balance.

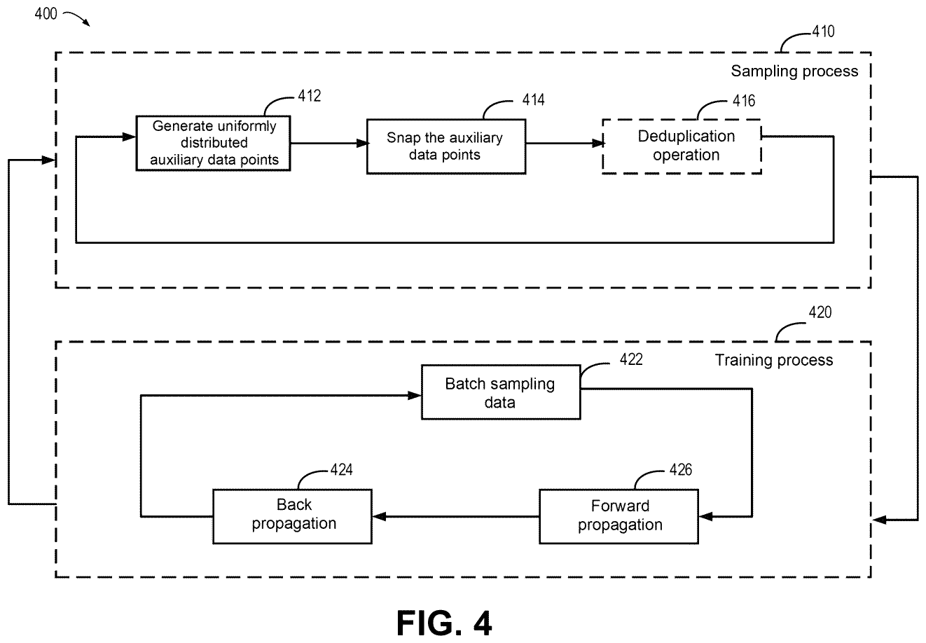

FIG. 4 illustrates an example block diagram of a training process 400 of performing training on a neural network model according to an embodiment of the present disclosure. The training process of the computing device 120 for the neural network model 122 may be divided into a plurality of epochs of training process 420. In other words, the computing device 120 may perform a plurality of training processes 420 for the neural network model 122. As mentioned above, before each epoch of training process 420, the simulation data of CFD may be sampled through a sampling process 410 to obtain a set of CFD simulation sample data including a plurality of pieces of CFD simulation sample data during the epoch of training. The sampling process 410 in FIG. 4 includes an operation 412 of generating uniformly separated auxiliary data points, an operation 414 of snapping auxiliary data points, and a deduplication operation 416 (if necessary). The operations 412, 414, and 416 have been described with reference to FIG. 3, and may be understood in conjunction with the relevant content mentioned earlier. For clarity, such previous description will not be repeated here.

The training process 420 shown in FIG. 4 is a training process performed for the neural network model 122. The process may represent each epoch of training process performed for the neural network model 122. Batch sampling data 422 in each epoch of training process 420 may come from a set of CFD simulation sample data including a plurality of pieces of CFD simulation sample data sampled in the sampling process 410, and each epoch of training process 420 has a corresponding set of CFD simulation sample data. The computing device 120 may train the neural network model 122 based on the batch sampling data 422 sampled from the sampling process 410, and train the neural network model 122 through propagation processes including forward propagation 426 and backward propagation 424, the latter also being referred to as “back propagation.”

In some embodiments, the computing device 120 may perform the sampling process 410 and the training process 420 several times to obtain a trained neural network model 122 that meets a required degree of fitting.

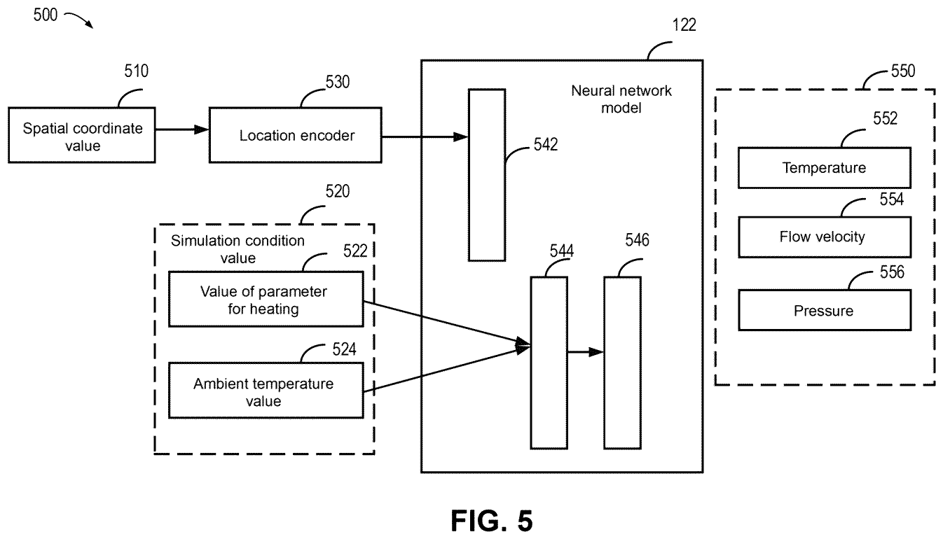

FIG. 5 is a block diagram of a system 500 comprising a neural network model 122 according to an embodiment of the present disclosure. In the training process, as mentioned earlier, the computing device 120 may use CFD simulation sample data 110 to train the neural network model 122. The CFD simulation sample data may include: sample data of an input parameter; a simulation condition sample value; and simulation sample data of a corresponding output parameter at the simulation condition sample value. The simulation condition sample in the CFD simulation sample data may include at least one of a value of a parameter for characterizing heating or a value of a parameter for characterizing the ambient temperature. The input parameter may include spatial coordinates in a mesh constructed based on the simulated object, and the output parameters may include one or more of temperature, flow velocity, or pressure.

As shown in FIG. 5, the CFD simulation sample data of the computing device 120 training the neural network may include a spatial coordinate sample value 510, a value 522 of a parameter characterizing heating (such as the processor load), an ambient temperature value 524 (such as the fan speed), and a sample value of an output parameter 550, including temperature 552, flow velocity 554, and pressure 556. As shown in FIG. 5, the value 522 of a parameter characterizing heating (such as the processor load) and the ambient temperature value 524 (such as the fan speed) constitute a simulation condition sample value 520.

In some embodiments, the spatial coordinate sample value 510 is input into a location encoder 530 and encoded by the location encoder 530. The encoded spatial coordinate value is input into the neural network model 122. In addition, the simulation condition sample value 520 is also input into the neural network model 122. As shown in FIG. 5, the neural network model 122 may include a plurality of multi-layer perceptron (MLP) blocks 542, 544, and 546. In some embodiments, each MLP block may include a plurality of neurons and have a residual connection and standardization layer. Various types of MLP structures may be used, as will be appreciated by those skilled in the art. In addition, although the MLP blocks 542, 544, and 546 are shown in FIG. 5, it is to be understood that the neural network model 122 may also include MLP blocks with more or less data.

The trained neural network model 122 may be used for providing CFD simulation data (such as one or more of temperature, flow velocity, or pressure). In such a process of using the trained neural network model 122, the trained neural network model 122 may receive a value of the input parameter (such as the spatial coordinate sample value 510) and simulation condition values (such as the value 522 of the parameter of heating and the ambient temperature value 524), and may output CFD simulation data, such as the temperature 552, the flow velocity 554, and the pressure 556. For the purpose of illustration, although values of input parameters, condition values, and values of output parameters are marked with the same reference numerals in the training process and the process of using the neural network model 122, it is to be understood that the values of input parameters, the condition values, and the values of output parameters used in the two processes may not necessarily be the same.

In addition, in some embodiments, the computing device 120 may further adjust the network capacity of the neural network model 122 according to a degree of fitting of the neural network determined in the training process. Specifically, the computing device 120 may determine the degree of fitting of the neural network model in response to performing at least one epoch of training on the neural network model. In some embodiments, the degree of fitting of the neural network model may be determined by a difference between the value of the output parameter value in the training process and a true value of the output parameter. Those skilled in the art may use various appropriate methods to determine the degree of fitting of the neural network model, which is not limited in the present disclosure.

The computing device 120 may adjust the network capacity of the neural network model based on the determined degree of fitting. For example, in response to the degree of fitting including underfitting, the computing device 120 may expand the network capacity of the neural network model by a predetermined number of times, such as twice. In response to the degree of fitting including overfitting, the computing device 120 may reduce the network capacity of the neural network model based on a binary search algorithm. For example, illustration is made by taking the current network model with a capacity of C as an example, and the capacity obtained by expanding the capacity thereof twice being 2C as an example. In the process of performing the binary search algorithm, the computing device 120 may obtain an intermediate value of 1.5 C between C and 2 C, and determine the degree of fitting of the neural network model in a range 1 [C, 1.5 C] and a range 2 [1.5 C, 2 C]. An appropriate capacity is determined for the neural network model 122 in the range having a better degree of fitting, and the range of the neural network model 122 is adjusted to the determined capacity. It is to be understood that those skilled in the art may use other appropriate methods to adjust the capacity of the neural network model 122 according to the degree of fitting, which is not limited in the present disclosure.

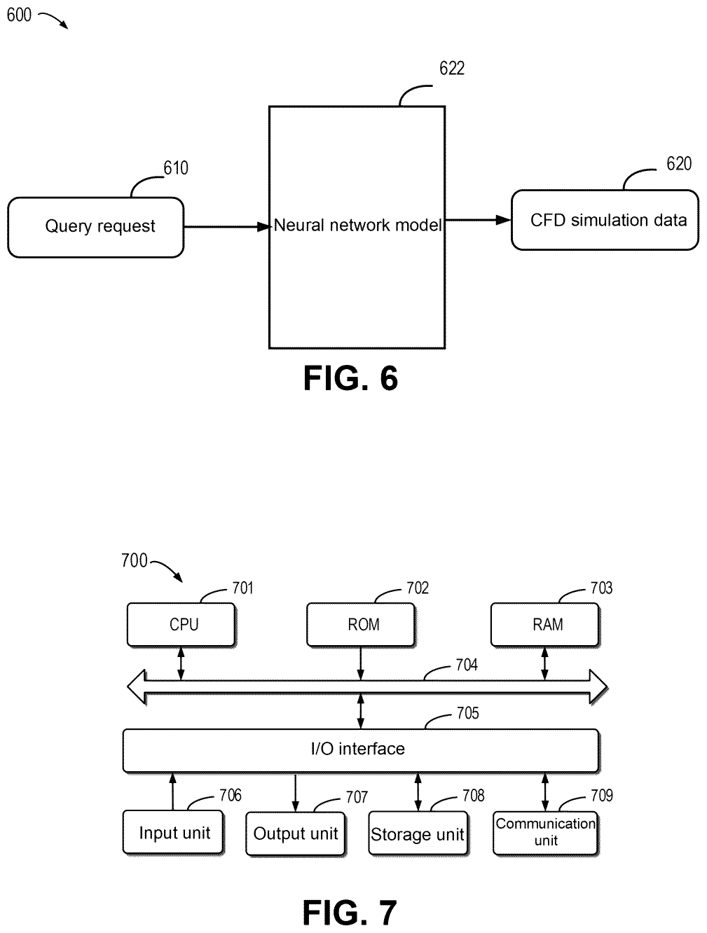

As mentioned above, the file 126 generated by the computing device 120 may be used to construct a neural network model 122 on another device to achieve a post-processing function for CFD simulation. FIG. 6 is a schematic diagram 600 of performing a query operation on a neural network model 122 according to an embodiment of the present disclosure.

A neural network model 622 in FIG. 6 may be a neural network model 622 reconstructed based on the file 126 by a device (for example, a second device) that is separate from the computing device 120. The neural network model 622 may receive a query request 610 and output CFD simulation data 620 corresponding to the query request 610.

In some embodiments, the query request 610 may include a first-type query request, and the first-type query request may include a coordinate location and a simulation condition value at a location to be queried. In some embodiments, the first-type query request may be represented in the form of a tuple: <coordinate value; simulation condition value>. For example, <x_{q}, y_{q}, z_{q}; a_{q}%; b_{q}>, wherein <z_{q}, y_{q}, z_{q}> is a query coordinate value, and the coordinate is a coordinate on a mesh constructed based on the simulated object; a_{q}% is the processor load of the device; and b_{q} is the fan speed. Depending on formats of the corresponding input parameter and output parameter in the training process, the neural network model 622 may provide the value of the output parameter corresponding to the query request based on the query request. For example, taking training a neural network model by using the sample data used in the training process shown in the above text as an example, the neural network model 622 may output the temperature, flow velocity, and pressure at the coordinate value <z_{q}, y_{q}, z_{q}> under the condition of (<a_{q}%; b_{q}>) in the query request.

In some embodiments, the query request 610 may also include a second-type query request, and the second-type query request may include a derivative of the first parameter with respect to the second parameter. For example, the derivative of the temperature with respect to the fan speed. The second-type query request supports gradient analysis of parameters by utilizing the automatic differentiation characteristic of the neural network. It may support gradient changes for parameters (for example, continuously changing parameters).

In some embodiments, the query request 610 may further include a third-type query request, and the third-type query request includes an integral change of a third parameter with respect to a fourth parameter. For example, the integration of flow velocity on the surface of an object may be queried to obtain the fluid flux on the surface.

In some embodiments, the query request 610 may further include a fourth-type query request, and the fourth-type query request may represent parameter scanning for continuously changing parameters. For example, the fourth-type query request may be used to acquire a curve between the temperature of the cooling air and the temperature of the processor, thereby providing users with multi-angle data analysis. In addition, the query request 610 may further include various types of custom-type query requests to obtain corresponding CFD simulation data through the neural network model 622.

FIG. 7 is a block diagram of an example device 700 which can be used to implement embodiments of the present disclosure. For example, the computing device 120 in FIG. 1 can be implemented by using the device 700. As shown in the figure, the device 700 includes a central processing unit (CPU) 701 that may execute various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The CPU 701, the ROM 702, and the RAM 703 are connected to each other through a bus 704. An Input/Output (I/O) interface 705 is also connected to the bus 704.

A plurality of components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The various processes and processing described above can be executed by CPU 701. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded into the RAM 703 and executed by the CPU 701, one or more actions of the method 200 for processing simulation data of CFD described above may be performed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, apparatus (system), and computer program product according to embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means for implementing the functions/acts specified in one or more blocks in the flow charts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various aspects of the functions/acts specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method comprising:
training, based on acquired computational fluid dynamics (CFD) simulation sample data, a neural network model to obtain a trained neural network model, wherein the CFD simulation sample data comprises: a CFD simulation condition sample value, sample data of an input parameter, and simulation sample data of an output parameter at the CFD simulation condition sample value; and
generating a file associated with the trained neural network model, wherein the file comprises a network parameter value of the trained neural network model, and the file is used for reconstructing the neural network model to provide CFD simulation data.

2. The method according to claim 1, wherein the file further comprises at least one of:
a range of coordinates, wherein the coordinates are associated with the shape of an object on which CFD simulation is performed;
a continuous range of a first parameter related to the CFD simulation;
a discrete range of a second parameter related to the CFD simulation; or
a confidence interval.

3. The method according to claim 1, wherein the acquired CFD simulation sample data comprises a plurality of sets of sampled CFD simulation sample data, and the plurality of sets of sampled CFD simulation sample data correspond to a plurality of epochs of training performed on the neural network model, respectively.

4. The method according to claim 3, further comprising:
before each epoch of training performed on the neural network model:
acquiring CFD simulation data associated with a simulated object; and
sampling from the CFD simulation data to acquire sampled CFD simulation sample data for the epoch of training.

5. The method according to claim 4, wherein sampling from the CFD simulation data comprises:
generating a plurality of uniformly distributed auxiliary data points in a data space corresponding to the CFD simulation data;
snapping, for each of the generated auxiliary data points, an auxiliary data point to a simulation data point nearest to the auxiliary data point;
removing, in response to two or more auxiliary data points being at the same location after being snapped, a duplicate auxiliary data point from the same location and retaining one auxiliary data point at the same location; and
using the snapped auxiliary data points in the data space as a set of sampled sample simulation data corresponding to the epoch of training.

6. The method according to claim 1, wherein the CFD simulation condition sample value comprises at least one of a value of a parameter for characterizing heating or a value of a parameter for characterizing the ambient temperature.

7. The method according to claim 1, further comprising:
determining, in response to performing at least one epoch of training on the neural network model, a degree of fitting of the neural network model; and
adjusting network capacity of the neural network model based on the degree of fitting.

8. The method according to claim 7, wherein adjusting the network capacity of the neural network model based on the degree of fitting comprises:
expanding, in response to the degree of fitting comprising underfitting, the network capacity of the neural network model by a predetermined number of times; or
reducing, in response to the degree of fitting comprising overfitting, the network capacity of the neural network model based on a binary search algorithm.

9. The method according to claim 1, wherein the neural network model is trained in a first device, and the file is used for reconstructing the trained neural network model in a second device to obtain corresponding CFD simulation data from the reconstructed neural network model by the second device based on a received query request.

10. The method according to claim 9, wherein the received query request comprises at least one of:
a first-type query request comprising a coordinate location of a location to be queried;
a second-type query request comprising a derivative of a first parameter for a second parameter;
a third-type query request comprising an integral change of a third parameter for a fourth parameter; or
a fourth-type query request representing parameter scanning for continuously changing parameters.

11. An electronic device, comprising:
at least one processor; and
a memory coupled to the at least one processor and having instructions stored therein, wherein the instructions, when executed by the at least one processor, cause the electronic device to perform actions comprising:
training, based on acquired computational fluid dynamics (CFD) simulation sample data, a neural network model to obtain a trained neural network model, wherein the CFD simulation sample data comprises: a CFD simulation condition sample value, sample data of an input parameter, and simulation sample data of an output parameter at the CFD simulation condition sample value; and
generating a file associated with the trained neural network model, wherein the file comprises a network parameter value of the trained neural network model, and the file is used for reconstructing the neural network model to provide CFD simulation data.

12. The electronic device according to claim 11, wherein the file further comprises at least one of:
a range of coordinates, wherein the coordinates are associated with the shape of an object on which CFD simulation is performed;
a continuous range of a first parameter related to the CFD simulation;
a discrete range of a second parameter related to the CFD simulation; or
a confidence interval.

13. The electronic device according to claim 11, wherein the acquired CFD simulation sample data comprises a plurality of sets of sampled CFD simulation sample data, and the plurality of sets of sampled CFD simulation sample data correspond to a plurality of epochs of training performed on the neural network model, respectively.

14. The electronic device according to claim 13, wherein the instructions, when executed by the at least one processor, further cause the electronic device to perform actions comprising:
before each epoch of training performed on the neural network model:
acquiring CFD simulation data associated with a simulated object; and
sampling from the CFD simulation data to acquire sampled CFD simulation sample data for the epoch of training.

15. The electronic device according to claim 14, wherein sampling from the CFD simulation data comprises:
generating a plurality of uniformly distributed auxiliary data points in a data space corresponding to the CFD simulation data;
snapping, for each of the generated auxiliary data points, an auxiliary data point to a simulation data point nearest to the auxiliary data point;
removing, in response to two or more auxiliary data points being at the same location after being snapped, a duplicate auxiliary data point from the same location and retaining one auxiliary data point at the same location; and
using the snapped auxiliary data points in the data space as a set of sampled sample simulation data corresponding to the epoch of training.

16. The electronic device according to claim 11, wherein the CFD simulation condition sample value comprises at least one of a value of a parameter for characterizing heating or a value of a parameter for characterizing the ambient temperature.

17. The electronic device according to claim 11, wherein the instructions, when executed by the at least one processor, further cause the electronic device to perform actions comprising:
determining, in response to performing at least one epoch of training on the neural network model, a degree of fitting of the neural network model; and
adjusting network capacity of the neural network model based on the degree of fitting.

18. The electronic device according to claim 17, wherein adjusting the network capacity of the neural network model based on the degree of fitting comprises:
expanding, in response to the degree of fitting comprising underfitting, the network capacity of the neural network model by a predetermined number of times; or
reducing, in response to the degree of fitting comprising overfitting, the network capacity of the neural network model based on a binary search algorithm.

19. The electronic device according to claim 11, wherein the neural network model is trained in a first device, and the file is used for reconstructing the trained neural network model in a second device to obtain corresponding CFD simulation data from the reconstructed neural network model by the second device based on a received query request.

20. A computer program product, the computer program product being tangibly stored on a non-transitory computer-readable medium and comprising machine-executable instructions, wherein the machine-executable instructions, when executed by a machine, cause the machine to perform actions comprising:
training, based on acquired computational fluid dynamics (CFD) simulation sample data, a neural network model to obtain a trained neural network model, wherein the CFD simulation sample data comprises: a CFD simulation condition sample value, sample data of an input parameter, and simulation sample data of an output parameter at the CFD simulation condition sample value; and
generating a file associated with the trained neural network model, wherein the file comprises a network parameter value of the neural network model, and the file is used for reconstructing the neural network model to provide CFD simulation data.
